(19) United States
(12) Patent Application Publication
(10) Pub. No.: US 2015/0323249 A1
(43) Pub. Date: Nov. 12, 2015

(54) PRE-CURING EQUIPMENT FOR ALIGNMENT LAYER

(71) Applicants: HEFEI BOE OPTOELECTRONICS TECHNOLOGY CO., LTD., Hefei, Anhui (CN); BOE TECHNOLOGY GROUP CO., LTD., Beijing (CN)

(72) Inventors: Ping WANG, Beijing (CN); Sangwoog KIM, Beijing (CN); Changyun ZUO, Beijing (CN); Jianzheng ZHANG, Beijing (CN); Yuan FANG, Beijing (CN)

(21) Appl. No.: 14/235,278

(22) PCT Filed: Oct. 12, 2013
(86) PCT No.: PCT/CN2013/085111

§ 371 Date: Jan. 27, 2014

(30) Foreign Application Priority Data
Apr. 22, 2013 (CN) 201310140471.8

(51) Int. Cl. F26B 3/20; F26B 23/04

(52) U.S. Cl. CPC F26B 3/20; F26B 23/04

(57) ABSTRACT

A pre-curing equipment for alignment layer is provided. The pre-curing equipment includes: a platform; a heating plate disposed below the platform; and a plurality of support needles configured to support a substrate, and disposed between the substrate and the platform. Each of the plurality of support needles has a tip end with a diameter in a range of 0.5 to 0.8 mm, and at least the tip end of each of the plurality of support needles is made of a heat insulating material.

### FIELD OF THE INVENTION

Embodiments of the present invention relate to a pre-curing equipment for alignment layer.

### BACKGROUND

A pre-curing equipment for alignment layer is an equipment for dry pre-curing an alignment layer, which process includes printing an alignment layer, heating a substrate with the alignment layer at middle-low temperature, and curing it at high temperature. Now, a typical way of pre-curing a substrate is heating the substrate by a heating plate.

As illustrated in FIG. 1, for example, a conventional pre-curing equipment for alignment layer includes a platform 10, a heating plate 20 disposed below the platform 10; and a plurality of support needles 30 disposed on the platform 10 and configured to support the substrate 40. The support needle has a tip end with a diameter about 1.8 mm.

For this conventional equipment, after the heating plate 20 is heated, the temperature of the support needles 30 will be higher than the environment temperature, which can result in quickly evaporating of the alignment layer solution coated on a surface of the substrate contacting the support needles 30 due to high temperature. In this case, quality of the alignment layer is compromised and the display using it will exhibit bright point(s) and thus bad image quality (e.g., mura).

### SUMMARY

Embodiments of the present invention provide a pre-curing equipment for alignment layer, which can avoid compromising the quality of alignment layer and thus the display image.

An aspect of the present invention provides a pre-curing equipment for alignment layer, comprising: a platform; a heating plate disposed below the platform; a plurality of support needles configured to support a substrate, and disposed between the substrate and the platform, wherein each of the plurality of support needles has a tip end with a diameter in a range of 0.5 to 0.8 mm, and at least the tip end of each of the plurality of support needles is made of a heat insulating material.

In an example, the heat insulating material has a heat resistant temperature in a range of 50-340° C. and a thermal conductivity in a range of 0 to 0.5 w/m²*k.

In an example, each of the plurality of support needles comprises a post and a needle head, the post is below the needle head and configured to support it, and the needle head is made of the heat insulating material.

In an example, the needle head has a tip end with a diameter of about 0.5 mm.

In an example, the post is made of SUS stainless steel.

In an example, the needle head is in a shape of cone; and the post is in a shape of cylinder.

In an example, the heat insulating material is polyether ether ketone (PEEK) or polyimide (PI).

In an example, the plurality of support needles extend through the platform and the heating plate.

In an example, the pre-curing equipment further comprises a fixing device disposed below the heating plate and configured to fix the plurality of support needles, wherein the fixing device does not contact with the heating plate.

In an example, the pre-curing equipment further comprises a lifting device configured to drive the fixing device up and down.

In an example, the pre-curing equipment further comprises a ventilating device disposed around the platform, wherein the ventilating device is spaced from the support needles by a distance larger than a thickness of the substrate.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 illustrates a structural schematic view of a conventional pre-curing equipment for alignment layer;

FIG. 2 illustrates a structural schematic view of a pre-curing equipment for alignment layer according to Embodiment 1 of the present invention;

FIG. 3 illustrates a structural schematic view of a pre-curing equipment for alignment layer according to Embodiment 2 of the present invention;

FIG. 4 illustrates a structural schematic view of a pre-curing equipment for alignment layer with a fixing device according to an embodiment of the present invention;

FIG. 5 illustrates a structural schematic view of a pre-curing equipment for alignment layer with a lifting device according to an embodiment of the present invention;

FIG. 6 illustrates a structural schematic view of a pre-curing equipment for alignment layer according to Embodiment 3 of the present invention.

In the accompanying drawings, the components represented by various numerals are as follows: 10—platform; 20—heating plate; 30—support needles; 301—needle head; 302—needle post; 40—substrate; 50—fixing device; 60—lifting device; 70—ventilating device.

### DETAILED DESCRIPTION OF THE PREFERRED EMBODIMENTS

In order to make the purposes, technical solutions and advantages of embodiments of the present invention more clear, technical solutions according to the embodiments of the present invention will be described clearly and completely below in conjunction with the accompanying drawings of embodiments of the present invention. It is to be understood that the described embodiments are part of but not all of exemplary embodiments of the present invention. Based on the described exemplary embodiments of the present invention, all other embodiments obtained by those of ordinary skill in the art without creative labor shall fall into the protection scope of the present invention.

Embodiment(s) of the present invention provides a pre-curing equipment for alignment layer, comprising: a platform 10; a heating plate 20 disposed below the platform 10; a plurality of support needles 30 configured to support a substrate 40, and disposed between the substrate 40 and the platform 10. Each of the plurality of support needles 30 has a tip end with a diameter in a range of 0.5 to 0.8 mm, and at least the tip end of each of the plurality of support needles 30 is made of a heat insulating material.

The heat insulating material can have a heat resistant temperature in a range of 50-340° C. and a thermal conductivity in a range of 0 to 0.5 w/m²*k, for example.

It is understood that the heat insulating material can be plastics with high thermal resistance temperature and low thermal conductivity, such as polyether ether ketone (PEEK), or polyimide (PI); and it also can be other materials with high thermal resistance temperature and poor thermal conductivity; but not limited to thereof.

It is understood that the support needles 30 can be numerous as actual requirement.

It is understood that the support needles 30 can be distributed in a manner so that the supported substrate 40 is not deformed during the pre-curing process.

It is understood that all the support needles 30 have equal length which can be designed as actual requirement.

In embodiments of the present invention, the substrate 40 refers to a substrate including an alignment layer.

The tip end of each support needles has a diameter in a range of 0.5 to 0.8 mm, and the tip end refers to the tip end surface of the support needles 30 which contacts the substrate 40; if the tip end is circular, the diameter refers to the diameter of the circle, and if the tip end is not circular, it refers to the longest length between any two points on the periphery of the tip end.

In each of the support needles 30, at least the portion of the tip end is made of heat insulating materials. For example, the whole support needle 30 can be made of heat insulating material PEEK or PI, so that it can be produced integrally, which allows a simple process, if there is no consideration of the production cost. Alternatively, the tip portion of the support needles 30 can be made of heat insulating material, while the other portion of the support needles 30 can be made of other high temperature material, such as SUS stainless steel.

Within control range of the product cost, the length of the portion of the needles made of thermal insulating material can be selected as long as possible. As such, it is possible to reduce the heat transferred to the surface of the substrate 40 via the support needles 30.

Embodiments of the present invention provide a pre-curing equipment for alignment layer, comprising a platform 10; a heating plate 20 disposed below the platform 10; and a plurality of support needles 30 configured to support a substrate 40, and disposed between the substrate 40 and the platform 10. For example, each of the plurality of support needles 30 has a tip end with a diameter in a range of 0.5 to 0.8 mm, and at least the tip end of each of the plurality of support needles 30 is made of a heat insulating material. As such, since the contact area of the tip end of each of the support needles and the substrate 40 is smaller, and the heat insulating material has characteristics of high thermal resistance temperature and low thermal conductivity, the heat transferred to the surface of the substrate 40 via the needles 30 is reduced. In such a way, the substrate 40 can be heated uniformly, so that the solution of the alignment layer can be evaporated uniformly and compromised quality of the alignment layer and thus poor display image quality can be avoided.

The heat insulating material can be PEEK, or PI, for example.

### Embodiment 1

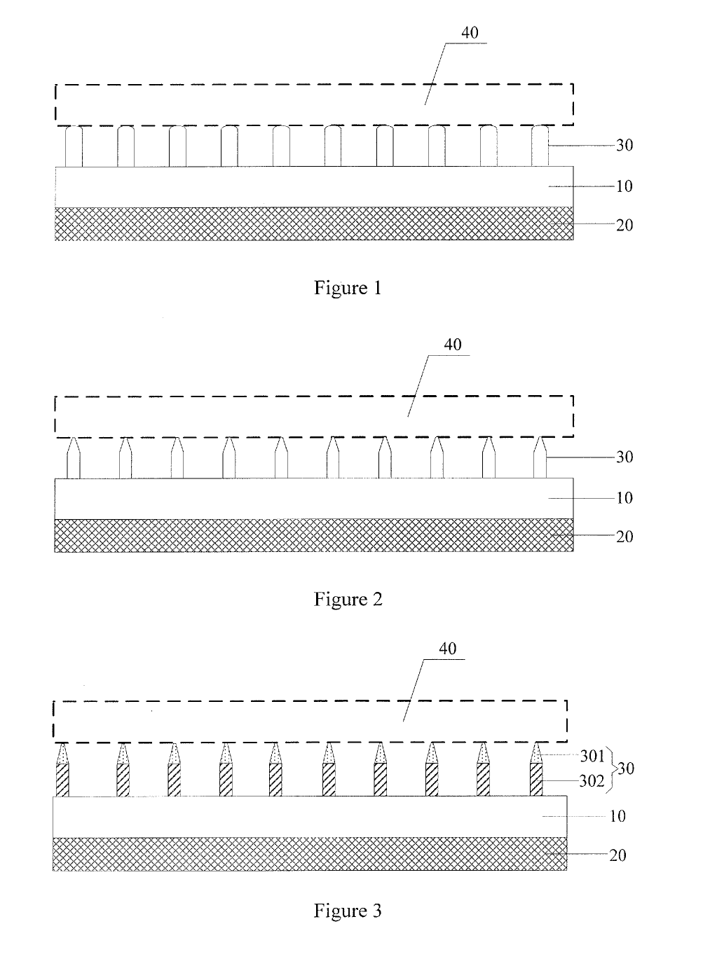

The embodiment of the present invention provides a pre-curing equipment for alignment layer. As illustrated in FIG. 2, the pre-curing equipment includes a platform 10; a heating plate 20 disposed below the platform 10; and a plurality of support needles 30 configured to support a substrate 40, and disposed between the substrate 40 and the platform 10.

Each of the plurality of support needles 30 has a tip end with a diameter about 0.5 mm, and each of the plurality of support needles 30 is made of PEEK or PI, for example.

As such, on the one hand, since both the PEEK and the PI have characteristics of high thermal resistance temperature and low thermal conductivity, when each of the support needles 30 is made of PEEK or PI, the heat transferred to the surface of the substrate 40 via the support needles 30 is reduced. On the other hand, since the tip end of the each of the support needles 30 has a diameter only about 0.5 mm, i.e., the contact area of the tip end of each of the support needles 30 and the substrate 40 is smaller, the heat transferred to the corresponding spot of the surface of the substrate 40 can be further reduced, so that the substrate 40 can be heated uniformly, and thus the alignment layer solution can be evaporated uniformly and compromised quality of the alignment layer and thus poor display image quality can be avoided.

The characteristic of high temperature resistance of PI is in that it can be used under 300° C. for a long period of time. The characteristic of high temperature resistance of PEEK is in that it can be used under 250° C. for a long period of time. The thermal conductivity of PI is 0.3 w/m²*k, and that of PEEK is 0.25 w/m²*k.

Further, each of the support needles 30 includes a needle post 302 and needle head 301, and the post 302 is disposed below the needle head 301 to support it. The needle head is made of the heat insulating material.

It is understood that the length of the needle head 301 and needle post 302 can be designed as actual requirement, and the length of the needle head is preferred as long as possible.

Considering the complexity of fabricating process for the needle head 301, under the condition that the process can meet the requirement, the diameter of the tip end of the needle head 301 can be about 0.5 mm, for example.

The post 302 can be made of SUS stainless steel.

The SUS stainless steel has characteristics of anti-erosion for weak erosive material, such as air, steam, and water, and for chemical erosive material, such as acid, alkali and salt, and it is not expensive. Although its thermal conductivity is larger than that of PEEK or PI, by disposing the post 302 made of SUS stainless steel below the needle head 301, and by designing the length of the post 302 and the needle head 301 properly, heat transferred to the surface of the substrate 40 via the support needles 30 can also be reduced.

In such a manner, cost of the support needles 30 can be saved because the post 302 is made of non-expensive SUS stainless steel, while ensuring the whole substrate 40 being heated uniformly to allow the solution of the alignment layer to be evaporated uniformly.

The needle head 301 can be designed in a shape of cone, and the post 302 can be designed in a shape of a cylinder, for example.

### Embodiment 2

The embodiment of the present invention provides a pre-curing equipment for alignment layer. As illustrated in FIG. 3, the pre-curing equipment includes a platform 10; a heating plate 20 disposed below the platform 10; and a plurality of support needles 30 configured to support a substrate 40, and disposed between the substrate 40 and the platform 10. Each of the plurality of support needles 30 includes a needle head 301 and a post 302, and the post 302 is disposed below the needle head 301 to support it.

The needle head 301 can be designed in a shape of cone, and its tip end has a diameter about 0.5 mm, and the post can be designed in a shape of cylinder. The needle head 301 can be made of PEEK or PI, and the post 302 can be made of SUS stainless steel.

As such, on one hand, since both the PEEK and the PI have characteristics of high thermal resistance temperature and low thermal conductivity, the needle head 301 made of PEEK or PI can reduce the heat transferred to the corresponding spot of the surface of the substrate 40 via the needle head 301. On the other hand, since the tip end of the needle head 301 has a diameter only about 0.5 mm, i.e., the contact area of each of the support needles 30 and the substrate 40 is smaller, the heat transferred to the corresponding spot of the surface of the substrate 40 can be further reduced, so that the substrate 40 can be heated uniformly, and thus the alignment layer solution can be evaporated uniformly and compromised alignment layer and thus poor display image quality can be avoided.

The plurality of support needles 30 can extend through the platform 10 and the heating plate 20. In this case, the pre-curing equipment for alignment layer further includes a fixing device 50, disposed below the heating plate 20 and for fixing the support needles 30, and the fixing device does not contact with the heating plate 20.

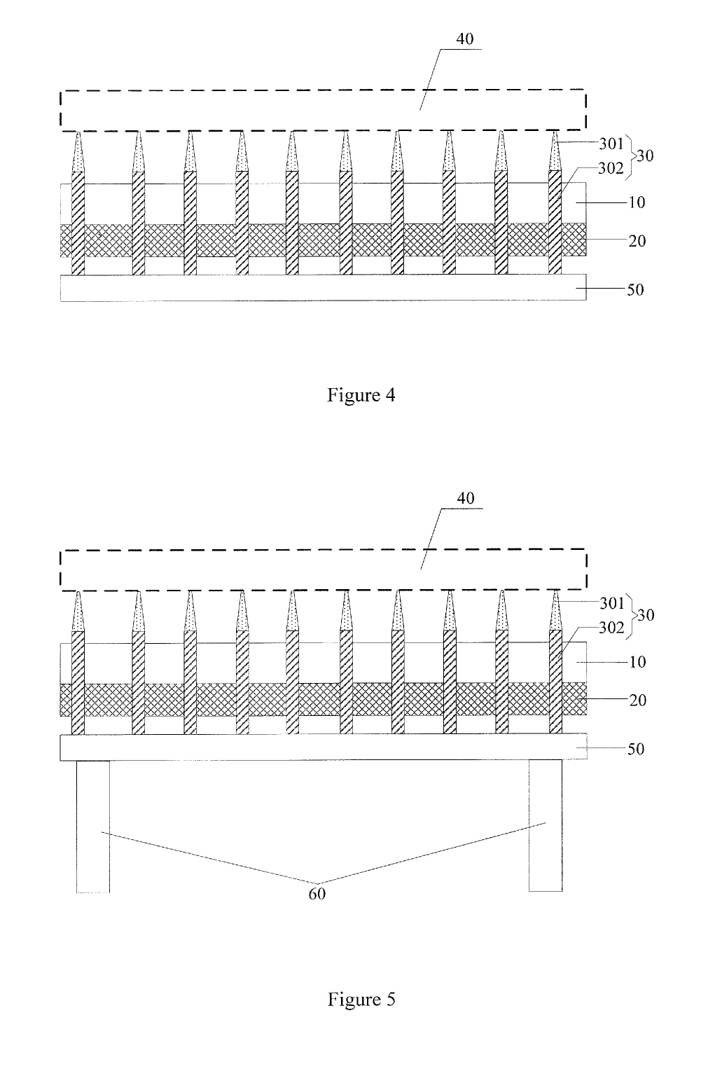

As illustrated in FIG. 4, for example, the fixing device can be a flat plate, the bottom of the post 302 of the support needles 30 can be fixed on the fixing device 50, so that the fixing device 50 can be configured to fix the support needles 30.

In this case, the plurality of support needles 30 extend through the platform 10 and the heating plate 20. For example, a plurality of hollow regions can be disposed in the platform 10 and the heating plate 20, and the hollow regions in the platform 10 correspond to the hollow regions in the heating plate 20. As such, part of the support needles 30 can be disposed in the hollow regions in the platform 10 and the heating plate 20, when the support needles 30 are fixed. For example, one part of the support needles 30 can be above the platform 10, and the remaining part of the support needles can be disposed below the heating plate 20.

For example, the pre-curing equipment for alignment layer further includes a lifting device 60 for driving the fixing device 50 up and down.

As the example illustrated in FIG. 5, the lifting device 60 can be disposed below the fixing device 50 and drive the fixing device 50 up and down.

In such a manner, the support needles 30 fixed on the fixing device 50 can be driven to move. After the lifting device 60 drives the fixing device 50 to allow each of the support needles 30 thereon to move to a position, the substrate 40 is heated to allow the solution of the alignment layer to be evaporated, so that the pre-curing process is performed. When the lifting device 60 drives the fixing device 50 to allow the support needles 30 thereon to go through the platform 10 and up to a position, the substrate 40 can be handled by a robot in the upstream and downstream.

For example, the pre-curing equipment for alignment layer further includes a ventilating device 70 disposed around the platform 10, and the ventilating device 70 is spaced apart from the support needles 30 by a distance larger than a thickness of the substrate 40.

In this case, the ventilating device 70 being spaced apart from the support needles 30 by a distance larger than a thickness of the substrate 40 refers to that the substrate 40 will not contact with the ventilating device 70, wherever the substrate 40 supported by the support needles 30 are located.

Since the ventilating device 70 can vent air continuously, the present embodiment can further have the substrate 40 being heated uniformly, and facilitate the vaporizing of solvent in the alignment layer solution.

### Embodiment 3

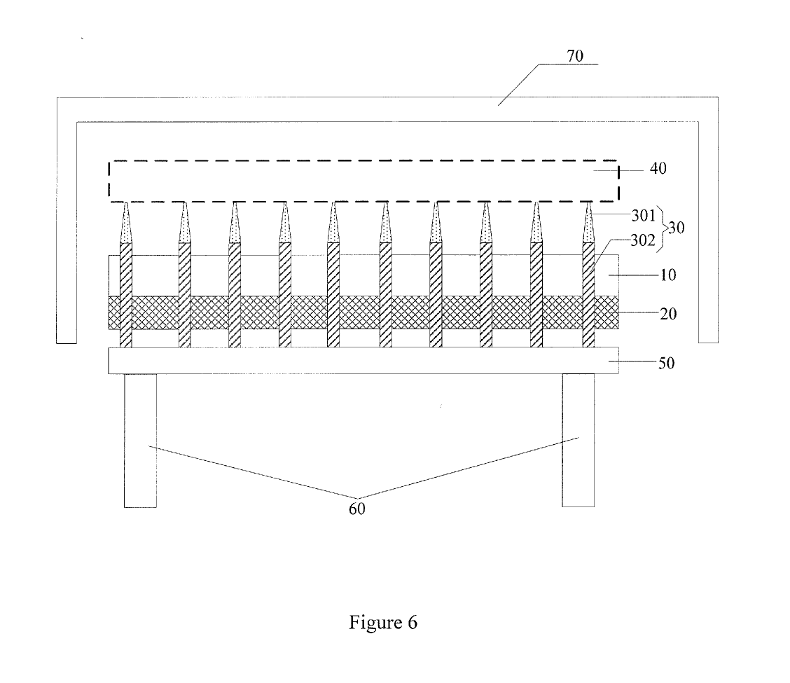

As illustrated in FIG. 6, the embodiment of the present invention provides a pre-curing equipment for alignment layer. The pre-curing equipment includes a platform 10; a heating plate 20 disposed below the platform 10; and a plurality of support needles 30 configured to support a substrate 40, and disposed between the substrate 40 and the platform 10 and extending through the platform 10 and the heating plate 20. The pre-curing equipment further includes a fixing device 50 configured to fix the support needles 30, a lifting device 60 configured to drive the fixing device 50 up and down, and a ventilating device 70 disposed around the platform 10.

Each of the plurality of support needles 30 includes a needle head 301 and a post 302, and the post 302 is disposed below the needle head 301 to support it. The fixing device 50 is disposed below the heating plate 20 and does not contact with it.

Each of the needle head 301 can be designed in a shape of cone, and its tip end has a diameter about 0.5 mm, and the post 302 can be designed in a shape of cylinder. The needle head 301 can be made of PEEK or PI, and the post 302 can be made of SUS stainless steel.

In this embodiment, the support needle 30 can be designed in a length of about 144.2 mm. Considering the cost of the needle head 301, it can be designed in a length of about 20 mm. In this case, the post 302 can be designed in a length of about 124.2 mm.

It is understood that the length of the support needles 30, the needle heads 301 and the posts 302 can be designed as actual requirements, and the length of the needle head is preferred as long as possible.

As such, on the one hand, since both the PEEK and the PI have characteristics of high thermal resistance temperature and low thermal conductivity, the needle head 301 made of PEEK or PI can reduce the heat transferred to the corresponding spot of the surface of the substrate 40 via the needle head 301. On the other hand, since the tip end of the needle head 301 has a diameter only about 0.5 mm, i.e., each of the support needles 30 contacts with the substrate 40 with a smaller contact area, the heat transferred to the corresponding spot of the surface of the substrate 40 can be further reduced, so that the substrate 40 can be heated uniformly. In such a manner, the alignment layer can be evaporated uniformly, and compromised alignment layer and thus poor display image quality can be avoided.

The embodiments of the invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

1. A pre-curing equipment for alignment layer, comprising:
a platform;
a heating plate disposed below the platform;
a plurality of support needles configured to support a substrate, and disposed between the substrate and the platform, wherein each of the plurality of support needles has a tip end with a diameter in a range of 0.5 to 0.8 mm, and at least the tip end of each of the plurality of support needles is made of a heat insulating material.

2. The pre-curing equipment according to claim 1, wherein the heat insulating material has a heat resistant temperature in a range of 50-340° C. and a thermal conductivity in a range of 0 to 0.5 w/m²*k.

3. The pre-curing equipment according to claim 1, wherein each of the plurality of support needles includes a post and a needle head, the post is disposed below the needle head and configured to support it, and the needle head is made of the heat insulating material.

4. The pre-curing equipment according to claim 3, wherein the needle head has a tip end with a diameter about 0.5 mm.

5. The pre-curing equipment according to claim 3, wherein the post is made of SUS stainless steel.

6. The pre-curing equipment according to claim 3, wherein the needle head is in a shape of cone; and the post is in a shape of cylinder.

7. The pre-curing equipment according to claim 1, wherein the heat insulating material is polyether ether ketone (PEEK) or polyimide (PI).

8. The pre-curing equipment according to claim 7, wherein the plurality of support needles extend through the platform and the heating plate.

9. The pre-curing equipment according to claim 8, further comprising a fixing device disposed below the heating plate and configured to fix the plurality of support needles, wherein the fixing device does not contact with the heating plate.

10. The pre-curing equipment according to claim 9, further comprising a lifting device configured to drive the fixing device up and down.

11. The pre-curing equipment according to claim 1, further comprising a ventilating device disposed around the platform, wherein the ventilating device is spaced from the support needles by a distance larger than a thickness of the substrate.

12. The pre-curing equipment according to claim 2, wherein each of the plurality of support needles includes a post and a needle head, the post is disposed below the needle head and configured to support it, and the needle head is made of the heat insulating material.

13. The pre-curing equipment according to claim 12, wherein the needle head has a tip end with a diameter about 0.5 mm.

14. The pre-curing equipment according to claim 13, wherein the post is made of SUS stainless steel.

15. The pre-curing equipment according to claim 13, wherein the needle head is in a shape of cone; and the post is in a shape of cylinder.

16. The pre-curing equipment according to claim 2, wherein the heat insulating material is polyether ether ketone (PEEK) or polyimide (PI).

17. The pre-curing equipment according to claim 3, wherein the heat insulating material is polyether ether ketone (PEEK) or polyimide (PI).

18. The pre-curing equipment according to claim 2, further comprising a ventilating device disposed around the platform, wherein the ventilating device is spaced from the support needles by a distance larger than a thickness of the substrate.

19. The pre-curing equipment according to claim 3, further comprising a ventilating device disposed around the platform, wherein the ventilating device is spaced from the support needles by a distance larger than a thickness of the substrate.

20. The pre-curing equipment according to claim 4, further comprising a ventilating device disposed around the platform, wherein the ventilating device is spaced from the support needles by a distance larger than a thickness of the substrate.
